(19) United States
(12) Patent Application Publication
(10) Pub. No.: US 2009/0076183 A1
(43) Pub. Date: Mar. 19, 2009

(54) Radiation curable methacrylate polyesters

(76) Inventors: John Jun Chiao, Marietta, GA (US); JoAnn Arceneaux, Marietta, GA (US)

Correspondence Address: WENDEROTH, LIND & PONACK, L.L.P., 2033 K STREET N. W., SUITE 800, WASHINGTON, DC, 20006-1021, US

(21) Appl. No.: 11/919,743

(22) PCT Filed: Apr. 28, 2006
(86) PCT No.: PCT/EP2006/004012

§ 371 Date: Dec. 20, 2007

Related U.S. Application Data
(60) Provisional application No. 60/677,346, filed on May 4, 2005.

(51) Int. Cl. C08F 2/48; C08G 63/668; C08F 2/46

(52) U.S. Cl. 522/101; 528/112

(57) ABSTRACT

A radiation curable composition comprising a (meth)acrylated polyester having unsaturated (meth)acrylic groups on the molecules, responding to formula (I) or formula (II) wherein each D, independently, represents ethylene or propylene, x, y is an integer from (1) to (50), each A, independently, represent hydrogen, alkyl, alkenyl, with the proviso that adjacent A's can be linked together to form a cycle, each B, independently, represents an alkylene or alkenylene chain, optionally comprising one or more ether bridges, each R, independently, represents hydrogen or methyl.

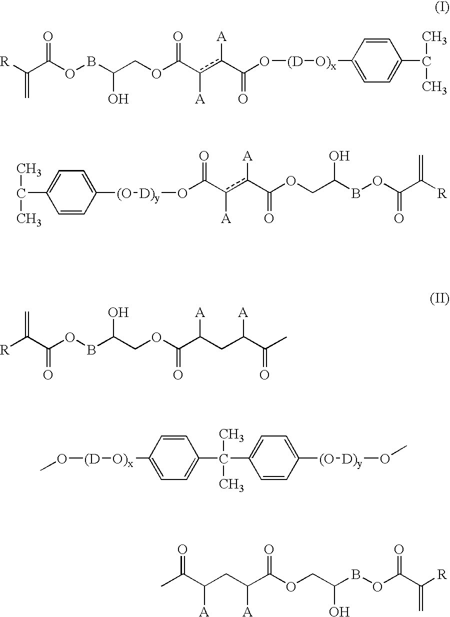

### BACKGROUND OF THE INVENTION

1. Field of the Invention

The present invention relates to the field of radiation curable compositions, particularly to radiation curable (meth)acrylate polyesters useful for coatings, printing inks, adhesives and sealants, electronics, photopolymers, and dental materials.

2. Related Art to the Invention

Radiation curable compositions are preferably chosen in many surface treatment applications due to the advantages from their environmentally friendly nature. Radiation curable compositions are essentially 100% reactive solids systems. They generally contain no volatile organic compounds and yield almost no emissions. They can be cured with low energy consumption, high curing speed and good process control to give products with improved quality. Most radiation curable compositions employ ethylenically unsaturated compounds, including both acrylates and methacrylates, for curing reactions initiated by ultraviolet light or electron beam. For various end uses, these compounds also consist of backbones such as hydrocarbon, polyether, polyester, polyurethane, acrylics, silicone, amino and epoxy to impart desired performances.

Compared with their acrylated counterparts, radiation curable methacrylated compositions possess their own unique properties, such as better mechanical strength and higher hardness, which are desirable in applications like automotive coatings and dental materials. Radiation curable methacrylated compositions are also more frequently used in many electronics applications than the acrylated products, as the former yield better pattern definition in microelectronics processing. And special treatments such as applying protective film offset the curing speed difference between acrylates and methacrylates caused by oxygen inhibition.

It is also known, however, that radiation curable methacrylated compositions cure at relatively slower speeds, which affect productivity and may cause insufficient curing. To compensate for slow cure, the methacrylated compositions for UV curing can be made with higher level of photoinitiators. But the use of high levels of photoinitiators has a number of drawbacks. Since not all photoinitiators are consumed in curing reactions, free photoinitiator molecules can compromise product properties, and migrate to the surface to cause contamination in the final product. Certain photoinitiators also possess high odors.

Radiation curable (meth)acrylates are prepared by a number of chemical processes known to the field. Polyols and resins with hydroxyl functional groups are sometimes transformed into (meth)acrylated resins by esterification reactions, the most straightforward route. Both direct esterification and transesterification are conducted at elevated temperatures, at which the reaction mixtures may be susceptible to stability problems caused by unwanted radical polymerization. Direct esterification of alcohols with acrylic acid or methacrylic acid typically requires the presence of flammable organic solvents and strong acids as catalyst. Post-reaction treatment usually follows to remove solvents and other reaction ingredients. This leads to large amount of organic and aqueous wastes that add to environmental concerns and production costs. In addition, esterification processes obviously have their own limitations and do not fit all systems. For example, some reaction mixtures may be difficult for post-esterification treatment due to solubility and compatibility problems.

U.S. Pat. Nos. 3,089,863 and 4,659,778 provided a process to make polyesters by reactions involving a polyol, a dicarboxylic anhydride and a monoepoxide. U.S. Pat. No. 5,002,976 adopted this approach to prepare acrylated polyester compositions for radiation curable applications. The invented compositions were prepared by employing polyoxytetramethylene glycol, succinic anhydride or phthalic anhydride, and glycidyl acrylate as reactants. U.S. Pat. No. 4,158,618 disclosed radiation curable (meth)acrylated compositions prepared from a reactive polymer, halogenated cyclic anhydride and glycidyl ester. In addition, several other polyester composition examples can be found with combinations of specific alcohols, anhydrides and epoxy compounds. For example, methacrylated polyester compositions were made from hydroxy terminated polybutadiene, as described in U.S. Pat. No. 5,587,433 and JP Patent 04154823 A2.

It is an object of the present invention to provide radiation curable (meth)acrylated polyester compositions made from alkoxylated bis-phenol A polyol and a wide array of backbone components for other key reactants by a more environmentally friendly process that uses no organic solvents and requires no post-reaction treatments. It is a further object of the invention to provide radiation curable compositions with enhanced performance for a wide range of applications. These and other objects will be apparent from the description that follows.

### SUMMARY OF THE INVENTION

This invention is directed to radiation curable composition comprising a (meth)acrylated polyester having unsaturated (meth)acrylic groups on the molecules, responding to formula (I)

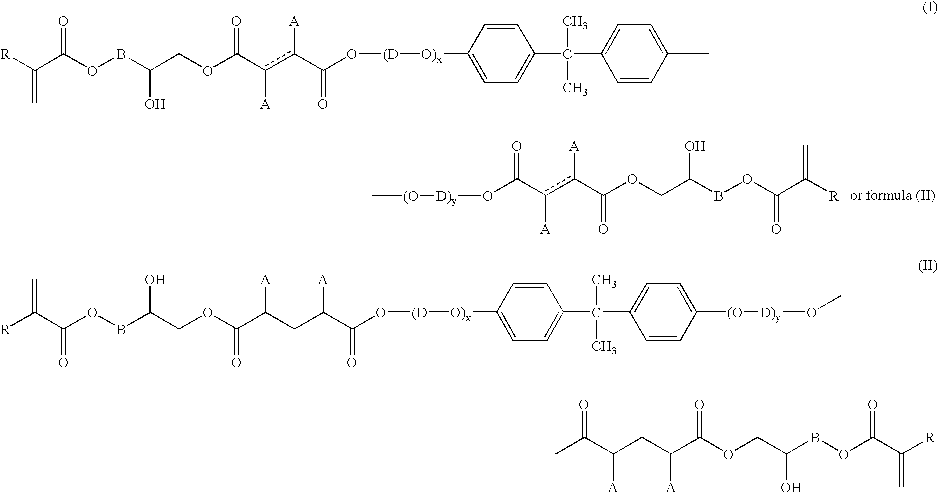

wherein
each D, independently, represents ethylene or propylene,
x, y is an integer from 0 to 50, (x+y) being an integer from 1 to 50,
each A, independently, represent hydrogen, alkyl, alkenyl, with the proviso that adjacent A's can be linked together to form a cycle,
each B, independently, represents an alkylene or alkenylene chain, optionally comprising one or more ether bridges,
each R, independently, represents hydrogen or methyl.
   In another aspect, this invention pertains to (meth)acrylated polyesters that are the reaction product of an alkoxylated bis-phenol A polyol with a cyclic anhydride and an epoxy-group bearing (meth)acrylate. In another aspect, this invention relates to radiation curable compositions with such (meth)acrylate polyesters as a component of equal or greater than 5% by weight.

The (meth)acrylated polyesters of this invention contain unsaturated (meth)acrylic groups and are preferably made by reacting an alkoxylated bis-phenol A polyol, a cyclic anhydride and an epoxy group-bearing (meth)acrylate. The (meth)acrylated polyesters of this invention are more preferably made in a one-pot process that is environmentally friendly, in most cases requires no organic solvents and is waste free. The ratio of the polyol, the cyclic anhydride, and the epoxy group-bearing (meth)acrylate is usually one mole of hydroxy groups on the polyol to one mole of the anhydride, and one mole of the epoxy group-bearing (meth)acrylate. Yet the ratio of the reactants can vary at will for one mole of hydroxy groups on the alcohol to 0.01 to 1 mole of the anhydride, and for one mole of the carboxyl groups to 0.01 to 1 mole of the epoxy group-bearing (meth)acrylate.

When it is deemed necessary for specific applications, the secondary alcohol groups (which have appeared from the reaction between the epoxy and the carboxyl groups) in the so obtained product can be further reacted with 0.01 to 1 mole of an anhydride, for giving an ester and a carboxyl group.

Also, the polyol used to make the (meth)acrylated polyesters of this invention can be a mixture of ethoxylated and propoxylated polyols; the same holds for the cyclic anhydride and the epoxy group-bearing (meth)acrylate.

When (meth)acrylated polyesters of this invention are formulated with other ethylenically unsaturated radiation curable compounds and other necessary components, the radiation curable compositions of this invention can be utilized as coating, ink, adhesive, sealant, electronics, photopolymer and dental compositions and can be cured by ultraviolet light or electron beams. These compositions are found to cure at higher rates than those of (meth)acrylated polyesters made by conventional processes.

### DESCRIPTION OF THE INVENTION

In the (meth)acrylated polyester having unsaturated (meth)acrylic groups on the molecules responding to formula (I), x+y is preferably at least 2, more preferably at least 3. x+y preferably does not exceed 100, more preferably not 30.

In the (meth)acrylated polyester having unsaturated (meth)acrylic groups on the molecules responding to formula (I), each A is preferably chosen from the group of hydrogen or adjacent A's are linked so that the form an alkylene or alkenylene cycle. In the latter case the alkylene or alkenylene cycle comprises preferably 5 or 6 carbon atoms.

In the (meth)acrylated polyester having unsaturated (meth)acrylic groups on the molecules responding to formula (I), B is preferably an alkylene. The (meth)acrylated polyesters of this invention are preferably prepared by a one-pot process using chemical reactions similar to that described in U.S. Pat. Nos. 3,089,863 and 5,002,976, which is hereby incorporated as reference. The preparation can be carried out in two steps within the same reaction vessel. The first step involves the reaction of an alkoxylated bis-phenol A polyol with a cyclic anhydride to form ester groups and terminal carboxyl groups. The second step follows by reacting the carboxyl groups formed from the first step with epoxy groups from an epoxy group-bearing (meth)acrylate introduced into the reaction mixture. The key criteria for completing the preparation are meeting target acid value and weight per epoxy. The reaction product so obtained may be illustrated by following formula:

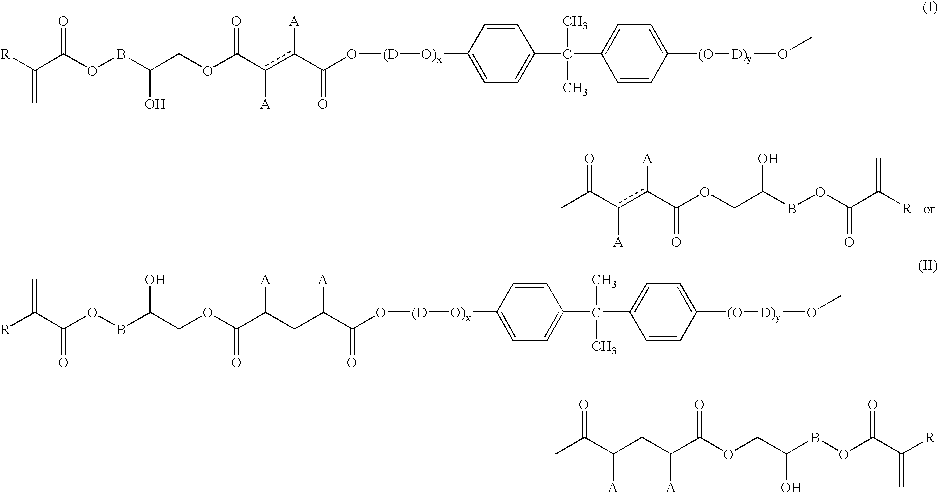

wherein
each D, independently, represents ethylene or propylene,
x, y is an integer from 1 to 50,
each A, independently, represent hydrogen, alkyl, alkenyl, with the proviso that adjacent A's can be linked together to form a cycle,
each B, independently, represents an alkylene or alkenylene chain, optionally comprising one or more ether bridges,
each R, independently, represents hydrogen or methyl. [symbol]
   In this formula “A” represents the residue of the anhydride; each [symbol] represents a double or a single bound; “B” represents the residue between the epoxy and methacrylate groups in the epoxy-methacrylate compound used.

1. The chemical reaction between an alcohol and a cyclic anhydride readily takes place when the two reactants are mixed and heated to suitable temperature.

However, the reactivity order of primary alcohol>secondary alcohol>tertiary alcohol makes primary and secondary alcohols more favorable choice over low reactive tertiary alcohols. The alcohol selected also depends on the usefulness of the backbone it bears in the applications of the compositions of the invention. Examples of the suitable alcohols of this invention are alkoxylated bis-phenol A polyols, where the most common are ethoxylated bis-phenol A polyols, propoxylated bis-phenol A polyols, or a mixture of both. Preferred are alkoxylated bis-phenol A polyols having a molecular weight of about 272 to 5000, more specifically ethoxylated bis-phenol A polyols with a molecular weight between about 272 to 5000 or a hydroxy number between about 413 to 22 mg KOH/g, propoxylated bis-phenol A polyols with a molecular weight between about 286 to 5000 or a hydroxy number between about 393 to 22 mg KOH/g, or a mixture of two or more of such polyols.

The cyclic anhydrides useful in this invention are derived from dicarboxylic acids wherein the carboxyl groups are attached to adjacent carbon atoms. The cyclic anhydride preferably responds to the general structure of formula (III) or (IV)

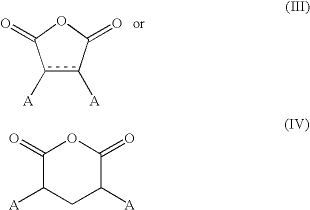

wherein each A, independently, represent hydrogen, alkyl, alkenyl, with the proviso that both A's can be linked together to form a cycle. These cyclic anhydrides preferably have molecular weights of about 98 to about 375. Examples of specific anhydrides include succinic anhydride, octenyl succinic anhydride, dodecenyl succinic anhydride, octadecenyl succinic anhydride, maleic anhydride, phthalic anhydride, tetrahydrophthalic anhydride, hexahydrophthalic anhydride, glutaric anhydride, methyl Nadic anhydride, chlorendic anhydride, itaconic anhydride, and the like. Preferred are succinic anhydride, phthalic anhydride and hexahydrophthalic anhydride.

The epoxy group-bearing (meth)acrylates used to make the (meth)acrylated polyesters of this invention are compounds that contain both at least one epoxy and at least one (meth)acrylate group. Epoxy group-bearing (meth)acrylate responding to the general structure of

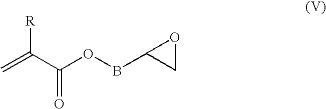

wherein B represents an alkylene or alkenylene, preferably with 1 to 20 carbon atoms, optionally comprising one or more ether bridges and R is hydrogen or methyl are preferred. Suitable examples of the epoxy group-bearing (meth)acrylates include glycidyl methacrylate, methylglycidyl methacrylate, 3,4-epoxycyclohexylmethyl methacrylate, 4-hydroxybutylmethacrylate glycidyl ether, 6-hydroxyhexylmethacrylate glycidyl ether, and the like. Preferred are epoxy methacrylates.

The ratio of the polyol, the cyclic anhydride, and the epoxy group-bearing (meth)acrylate is usually one mole of hydroxy groups on the polyol to one mole of the cyclic anhydride, and to one mole of the epoxy group-bearing (meth)acrylate. The ratio of the three reactants can also vary for one mole of hydroxy groups on the polyol to 0.01 to 1 mole of the anhydride, and for one mole of the free carboxyl groups to 0.01 to 1 mole of the epoxy group-bearing (meth)acrylate.

When it is deemed necessary for specific applications, the secondary alcohol groups (which have appeared from the reaction between the epoxy and the carboxyl groups) in the so obtained product can be further reacted with 0.01 to 1 mole of an anhydride, for giving an ester and a carboxyl group. Also, the polyol used to make the (meth)acrylate polyesters of this invention can be a mixture of several different polyols as well. The same holds for the cyclic anhydride and the epoxy group-bearing (meth)acrylate.

Preferably, catalysts are employed in the preparation of the (meth)acrylated polyesters of this invention to shorten reaction time and reduce by-products. Amines, triphenylphosphine, and organometallic compounds from chromium, tin, zinc, iron, bismuth and zirconium can all be used to catalyze the reactions. Examples of suitable catalysts are butyltin trichloride, dibutyltin dichloride, tributyltin chloride, dibutyltin diacetate, dibutyltin diacrylate, dibutyltin dilaurate, dibutyltin oxide, dioctyltin dichloride, dioctyltin dilaurate, dioctyltin oxide, tetramethyltin, tetrabutyltin, tetraoctyltin, and the like.

The exact process conditions under which the (meth)acrylated polyesters of this invention are prepared vary from one composition to another, depending on what combination of time and temperature will be best suited for the preparation. Ordinarily, temperatures within the range of 80 to 140° C., preferably 90 to 120° C., will be kept and the reactions will be carried out for a period of about 4 to 20 hours for various reactants employed. Both reactions involved in the preparation are exothermic, and can raise the reaction temperature. For better control of process temperature, the epoxy group-bearing (meth)acrylate can be incrementally introduced to the reaction vessel over a time period of, for example, 1 hour or longer. The preparation is completed when the conversion of the epoxy group-bearing (meth)acrylate is found to be substantially complete, which is monitored by titration analysis of in-process samples periodically taken from the reaction mixtures.

The (meth)acrylated polyesters of this invention can be formulated to become the radiation curable compositions of this invention. In the radiation curable compositions of this invention, the (meth)acrylated polyester accounts for at least 5% by weight to provide necessary performance. Other ethylenically unsaturated radiation curable compounds and other necessary components are included in the radiation curable compositions

The radiation curable composition of the invention preferably comprise a mixture of (A) about 5 to 95 weight percent of the (meth)acrylated polyester, (B) about 0 to 80 weight percent of an ethylenically unsaturated radiation curable compound different from (A), (C) about 0 to 50 weight percent of a monoethylenically unsaturated radiation polymerizable monomer, (D) about 0 to 5 weight percent of from one up to five photoinitiators, and (E) about 0 to 20 weight percent of other necessary additives and ingredients.

The compositions of the invention can be utilized as coating, ink and adhesive compositions and can be cured by ultraviolet light or electron beams. These compositions are found in tests to cure at higher rates than those of (meth)acrylated polyesters made by conventional processes. The radiation curable composition are suitable for coating applications, for ink applications, for adhesive and sealant applications, for electronics coating applications, for photopolymer applications, for dental applications.

### EXAMPLES

The following examples illustrate the details of the invention. These examples are presented merely to demonstrate and not to limit the invention in any manner.

### Example 1

To a reaction vessel equipped with an agitator, an addition funnel and a thermometer were added 2,501.8 grams of ethoxylated bis-phenol A diol with a hydroxy number of 74.0 mg KOH/g, 330.2 grams of succinic anhydride, 3.3 grams of triphenyl antimony, and 1.1 grams of Hycat 2000 (a chromium-based catalyst from Dimension Technology Chemical Systems, Inc., Fair Oaks, Calif.). The mixture was then agitated and heated to 115° C. to react. The reaction was maintained at 115° C. for 2 hours. The reaction mixture was at this point a homogeneous solution.

Then 1.7 grams of 4-methoxyphenol and 2.2 grams of Hycat 2000 were added to the reaction vessel. 469.1 grams of glycidyl methacrylate was added to the reaction solution through the addition funnel over a period of 1 hour. The reaction was held at 110° C. for 3.5 hours, during which 10.0 grams of glycidyl methacrylate was added to adjust epoxy-acid balance.

The resulting product had an epoxy equivalent weight of 33,500, an acid value of 1.9 mg KOH/g, and a Brookfield viscosity of 4,130 cP at 25° C.

### Example 2

Using the same procedure as described in Example 1, a methacrylated polyester was prepared by reacting 2,312.1 grams of ethoxylated bis-phenol A diol with a hydroxy number of 172 mg KOH/g, 709.0 grams of succinic anhydride, and 1,051.8 grams of glycidyl methacrylate, using the same catalyst, inhibitor and stabilizer as described in Example 1.

The resulting product had an epoxy equivalent weight of 33,700, an acid value of 0.9 mg KOH/g, and a Brookfield viscosity of 17,400 cP at 25° C.

### Example 3

Using the same procedure as described in Example 1, a methacrylated polyester was prepared by reacting 1,726.2 grams of ethoxylated bis-phenol A diol with a hydroxy number of 312 mg KOH/g, 960.7 grams of succinic anhydride, and 1,370.7 grams of glycidyl methacrylate, using the same catalyst, inhibitor and stabilizer as described in Example 1.

The resulting product had an epoxy equivalent weight of 30,500, an acid value of 1.5 mg KOH/g, and a Brookfield viscosity of 281,000 cP at 25° C.

### Example 4

Using the same procedure as described in Example 1, a methacrylated polyester was prepared by reacting 1,952.0 grams of ethoxylated bis-phenol A diol with a hydroxy number of 230 mg KOH/g, 800.6 grams of succinic anhydride, and 1,172.4 grams of glycidyl methacrylate, using the same catalyst, inhibitor and stabilizer as described in Example 1.

The resulting product had an epoxy equivalent weight of 42,700, an acid value of 1.8 mg KOH/g, and a Brookfield viscosity of 57,100 cP at 25° C.

### Example 5

To a reaction vessel equipped with an agitator and a thermometer were added 1120.0 grams of the resulting product from Example 2 and the content was heated under agitation. When the temperature reached 110° C., 195.1 grams of succinic anhydride was introduced into the vessel, and the reaction was maintained at 110° C. for 3 hours.

The resulting product had an acid value of 81.8 mg KOH/g, and a Brookfield viscosity of 139,800 cP at 25° C.

### Example 6

Using the same procedure as described in Example 5, an acid-modified methacrylated polyester was prepared by reacting 1726.0 grams of the resulting product from Example 3 and 407.9 grams of succinic anhydride.

The resulting product had an acid value of 107.8 mg KOH/g, and a Brookfield viscosity of 12,530 cP at 60° C.

### Example 7

Using the same procedure as described in Example 1, a methacrylated polyester was prepared by reacting 1404.0 grams of ethoxylated bis-phenol A diol with a hydroxy number of 74.0 mg KOH/g, 185.3 grams of succinic anhydride, and 271.7 grams of glycidyl methacrylate, using the same catalyst, inhibitor and stabilizer as described in Example 1.

Using the same procedure as described in Example 6, the full content in the reaction vessel was combined with 182.1 grams of succinic anhydride to react.

The resulting product had an acid value of 51.2 mg KOH/g, and a Brookfield viscosity of 13,200 cP at 25° C.

### Example 8

This example illustrates the higher curing speeds achieved for the methacrylated polyesters of this invention as compared with corresponding methacrylates made by direct esterification processes of alkoxylated bis-phenol A diol.

Eight radiation curable compositions were prepared each by mixing 96.0 parts by weight of methacrylated compound identified in the table below and 4.0 parts by weight of Irgacure® 184 (product of Ciba Specialties Corporation USA, Glen Ellyn, Ill.) to become homogeneous solutions. Radiation curable compositions I through VIII were coated and irradiated with UV light by a typical UV curing procedure. The cure speeds are also listed in the following table. The non-marring state of the surface is determined by passing a fingernail or a tongue depressor on the surface, which is said to be non-marring if no scratches appear at the surface.

| | | UV Energy (mJ/cm²) to |
|---|---|---|
| Composition | Methacrylated Compound | Achieve Non-Marring Surface |
| I | the resulting product in | <440 |
| | Example 3 | |
| II | the resulting product in | <440 |
| | Example 4 | |
| III | the resulting product in | <440 |
| | Example 2 | |
| IV | the resulting product in | 440 to 880 |
| | Example 1 | |
| V | BPA(EO)₃DMA* | 2640 to 3080 |
| VI | BPA(EO)₆DMA* | 880-1320 |
| VII | BPA(EO)₃₀DMA* | 880-1320 |

*These methacrylates are products of Cytec Surface Specialties (Smyrna, GA), and the abbreviation signify “ethoxylated and dimethacrylated Bisphenol A”.

1. A radiation curable composition comprising a (meth)acrylated polyester having unsaturated (meth)acrylic groups on the molecules, responding to formula (I) 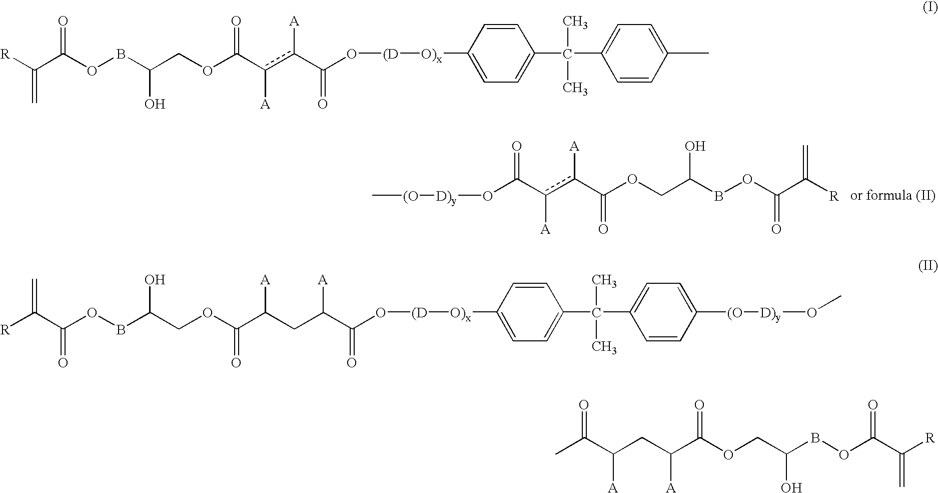
wherein
each D, independently, represents ethylene or propylene,
x, y is an integer from 1 to 50,
each A, independently, represent hydrogen, alkyl, alkenyl, with the proviso that adjacent A's can be linked together to form a cycle,
each B, independently, represents an alkylene or alkenylene chain, optionally comprising one or more ether bridges,
each R, independently, represents hydrogen or methyl.

2. The radiation curable composition according to claim 1, made by reacting (A) an alkoxylated bis-phenol A polyol with a molecular weight of about 272 to about 5,000, (B) cyclic anhydride in the mole ratio of one mole of hydroxy group to about between 0.01 to 1 mole of cyclic anhydride, and (C) epoxy group-bearing (meth)acrylate in the mole ratio of one mole of carboxyl groups from the cyclic anhydride to about 0.01 to 1 mole of epoxy group-bearing (meth)acrylate.

3. The radiation curable composition according to claim 2, wherein the reaction product is further reacted with 0.01 to 1 mole of a cyclic anhydride per mole of the hydroxyl groups of this product.

4. The radiation curable composition according to claim 2, wherein the polyol is an ethoxylated bis-phenol A polyol with a molecular weight between about 272 to 5000, or a hydroxy number between about 413 to 22 mg KOH/g, a propoxylated bisphenol A polyol with a molecular weight between about 286 to 5000, or a hydroxy number between about 393 to 22 mg KOH/g, or a mixture of two or more of such polyols.

5. The radiation curable composition according to claim 2, wherein the cyclic anhydride has the general structure of 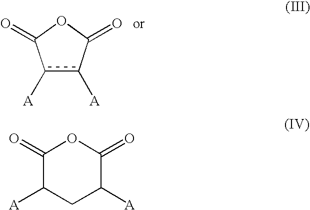
each A, independently, represent hydrogen, alkyl, alkenyl, with the proviso that both A's can be linked together to form a cycle.

6. The radiation curable composition according to claim 5, wherein the cyclic anhydride is selected from the group of succinic anhydride, octenyl succinic anhydride, dodecenyl succinic anhydride, octadecenyl succinic anhydride, maleic anhydride, phthalic anhydride, tetrahydrophthalic anhydride, hexahydrophthalic anhydride, glutaric anhydride, methyl-5-norbornene-2,3-dicarboxylic anhydride, chlorendic anhydride, itaconic anhydride and their mixtures.

7. The radiation curable composition according to claim 6, wherein the cyclic anhydride is succinic anhydride, phthalic anhydride or hexahydrophthalic anhydride.

8. The radiation curable composition according to claim 2, wherein the epoxy group-bearing (meth)acrylate has the general structure of 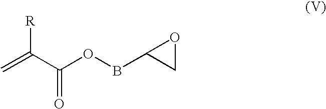
and B is alkylene or alkenylene with 1 to 20 carbon atoms, optionally comprising one or more ether bridges, R is hydrogen or methyl.

9. The radiation curable composition according to claim 8, wherein the epoxy group-bearing (meth)acrylate is glycidyl methacrylate, 3-hydroxypropylmethacrylate glycidyl ether, 4-hydroxybutylmethacrylate glycidyl ether or 6-hydroxyhexylmethacrylate glycidyl ether.

10. The radiation curable composition according to claim 2, wherein the polyol is ethoxylated bis-phenol A polyol with a molecular weight between about 272 to 5000, or a hydroxy number between about 413 to 22 mg KOH/g, the cyclic anhydride is succinic anhydride, and the epoxy group-bearing (meth)acrylate is glycidyl methacrylate.

11. The radiation curable composition according to claim 2, wherein the polyol is ethoxylated bis-phenol A polyol with a molecular weight between about 272 to 5000, or a hydroxy number between about 413 to 22 mg KOH/g, the cyclic anhydride is phthalic anhydride, and the epoxy group-bearing (meth)acrylate is glycidyl methacrylate.

12. The radiation curable composition according to claim 2, wherein the polyol is ethoxylated bis-phenol A polyol with a molecular weight between about 272 to 5000, or a hydroxy number between about 413 to 22 mg KOH/g, the cyclic anhydride is maleic anhydride, and the epoxy group-bearing (meth)acrylate is glycidyl methacrylate.

13. The radiation curable composition according to claim 2, wherein the polyol is ethoxylated bis-phenol A polyol with a molecular weight between about 272 to 5000, or a hydroxy number between about 413 to 22 mg KOH/g, the cyclic anhydride is hexahydrophthalic anhydride, and the epoxy group-bearing (meth)acrylate is glycidyl methacrylate.

14. The radiation curable composition comprising a mixture of (A) about 5 to 95 weight percent of the (meth)acrylated polyester in claim 1, (B) about 0 to 80 weight percent of an ethylenically unsaturated radiation curable compound different from (A), (C) about 0 to 50 weight percent of a monoethylenically unsaturated radiation polymerizable monomer, (D) about 0 to 5 weight percent of from one up to five photoinitiators, and (E) about 0 to 20 weight percent of other necessary additives and ingredients.

15. The radiation curable composition prepared by curing a radiation curable composition in claim 14 by ultraviolet light or electron beam.

16. Coatings, inks, adhesives, sealants or electronics coatings comprising the radiation curable composition of claim 14.

17. Dry film photoresists, digital versatile disc (DVD) adhesives and conformal coatings for printed circuits, photopolymers or dental applications comprising the radiation curable composition of claim 14.
